(19) United States
(12) Patent Application Publication
(10) Pub. No.: US 2016/0352565 A1
(43) Pub. Date: Dec. 1, 2016

(54) MEASUREMENT SYSTEM HAVING A PLURALITY OF SENSORS

(71) Applicants: METTLER TOLEDO (CHANGZHOU)PRECISION INSTRUMENT LTD, Jiangsu (CN); METTLER TOLEDO (CHANGZHOU) MEASUREMENT TECH. LTD., Jiangsu (CN); METTLER TOLEDO (CHANGZHOU) SCALE & SYSTEM LTD., Jiangsu (CN)

(72) Inventors: Feng DAI, Jiangsu (CN); Guojun XIE, Jiangsu (CN); Shaowen ZHENG, Jiangsu (CN)

(73) Assignees: METTLER TOLEDO (CHANGZHOU)PRECISION INSTRUMENT LTD, Jiangsu, OT (CN); METTLER TOLEDO (CHANGZHOU) MEASUREMENT TECH. LTD., Jiangsu, OT (CN); METTLER TOLEDO (CHANGZHOU) SCALE & SYSTEM LTD., Jiangsu, OT (CN)

(21) Appl. No.: 15/167,020

(22) Filed: May 27, 2016

Related U.S. Application Data
(63) Continuation of application No. PCT/CN2014/092463, filed on Nov. 28, 2014.

(30) Foreign Application Priority Data
Nov. 28, 2013 (CN) 201310629827.4

(51) Int. Cl. H04L 12/24; G05B 23/02; G05B 19/04; H04L 1/18

(52) U.S. Cl. CPC H04L 41/0668; H04L 1/188; G05B 23/0297; G05B 19/04; H04L 12/403

(57) ABSTRACT

A disclosed measurement system is constituted by a plurality of sensors coupled together via a bus. Each sensor can include a master system part and a slave system part. The measurement system can include a master sensor, wherein when the master system part of the master sensor is activated, the master sensor is used to collect, aggregate, and analyze information from all the slave sensors and/or from the master sensor per se; and a plurality of slave sensors, wherein when the master system part of each slave sensor is dormant while the slave system part of each slave sensor is activated, the slave sensor is used to collect and process information and deliver collected and processed information to the master sensor. When a fault occurs in the master sensor, one of the plurality of slave sensors can switch to become a new master sensor.

### RELATED APPLICATION

This application claims priority as a continuation application under 35 U.S.C. §120 to PCT/CN2014/092463, which was filed as an International Application on Nov. 28, 2014 designating the U.S., and which claims priority to Chinese Application 201310629827.4 filed in China on Nov. 28, 2013. The entire contents of these applications are hereby incorporated by reference in their entireties.

### FIELD

The present invention relates to the field of measuring and testing, and to a measurement system having a plurality of sensors.

### BACKGROUND

Measurement systems can collect signals with a plurality of sensors, aggregate the signals into a computer or instrument for signal processing, and provide an output in a unified manner. The system implementation can be complicated and include high costs. Further, the tolerance of the computer or instrument to the environment can be relatively low compared to sensors. In addition, when a fault occurs in the computer or instrument, the whole measurement system cannot function normally.

### SUMMARY

A measurement system is disclosed comprising: a plurality of sensors, the plurality of sensors being coupled together via a bus, each of the sensors being identical in physical structure and having a master system part and a slave system part; one master sensor, wherein when the master system part of the master sensor is activated, the master sensor being configured to collect, aggregate, and analyze information from the slave sensors and/or from the master sensor per se; and a plurality of slave sensors, wherein the master system part of each slave sensor is dormant while the slave system part of each slave sensor is activated, each slave sensor being configured to collect and process information and deliver the collected and processed information to the master sensor; wherein the plurality of sensors are configured to respond when a fault occurs in the master sensor, such that one of the plurality of slave sensors will switch to become a new master sensor.

### BRIEF DESCRIPTION OF DRAWINGS

Accompanied drawings are included to provide a further understanding of the present invention, and are included and formed as a part of the present disclosure. Exemplary embodiments of the present disclosure are illustrated in accompanying drawings and are used to explain the principles of the present invention together with this description. In the drawings:

FIG. 1 shows a measurement system having a plurality of sensors according to an exemplary embodiment of the present disclosure;

FIG. 2 shows an exemplary internal functional module diagram of a master sensor and a slave sensor according to an exemplary embodiment of the present disclosure;

FIG. 3 shows an internal functional module diagram of a monitor sensor and a guard sensor according to an exemplary embodiment of the present disclosure; and

FIG. 4 shows an exemplary flow chart of a method by which a plurality of monitor sensors compete to become a master sensor after a fault occurs in the master sensor.

### DETAILED DESCRIPTION

A measurement system as disclosed herein can have a plurality of sensors that is less complicated, supports multi-machine hot backup, and has high tolerance to environment conditions.

According to an exemplary aspect of the present disclosure, a measurement system constituted by a plurality of sensor is provided. The plurality of sensors are coupled together via a bus. Each of the sensors can be identical in physical structure and includes a master system part and a slave system part. The measurement system includes: one master sensor, wherein the master system part of the master sensor is activated, and the master sensor is used to collect, aggregate, and analyze information from all the slave sensors and/or from the master sensor per se; and a plurality of slave sensors, wherein the master system part of each slave sensor is dormant while the slave system part of each slave sensor is activated, and the slave sensor is used to collect and process information and deliver the collected and processed information to the master sensor. When a fault occurs in the master sensor, one of the plurality of slave sensors switches to become a new master sensor.

According to another exemplary aspect of the present disclosure, the plurality of slave sensors include at least one monitor sensor to monitor the status of the master sensor to determine whether a fault occurs in the master sensor, wherein when a fault occurs in the master sensor, one of the monitor sensors switches to the new master sensor.

According to another exemplary aspect of the present disclosure, the plurality of slave sensors include at least one guard sensor to monitor the status of the master sensor and the monitor sensors to determine whether a fault occurs, wherein when a fault occurs in the master sensor, the monitor sensors ask the guard sensors to select a new slave sensor to be a new monitor sensor.

According to another exemplary aspect of the present disclosure, the monitor sensor further monitors the status of the guard sensor to determine whether a fault occurs in the guard sensor, wherein when a fault occurs in the guard sensor, the monitor sensors directly designate a new slave sensor to be a new guard sensor.

According to another exemplary aspect of the present disclosure, the plurality of slave sensors include one monitor sensor, wherein when a fault occurs in the master sensor, the monitor sensor directly switches to the new master sensor.

According to another exemplary aspect of the present disclosure, the plurality of slave sensors include two or more monitor sensors, wherein when a fault occurs in the master sensor, one of the two or more monitor sensors switches to the new master sensor according to the following exemplary method: activating a master system part of a first monitor sensor, and broadcasting a first master system request to other monitor sensors in the measurement system, wherein the first master system request is a request intending to be a master sensor and includes the number of the first monitor sensor; determining whether there is any master system request from other monitor sensors within a first time threshold; reading information related to master system requests from other monitor sensors and determining whether the first master system request shall be abandoned if it is determined that there is a master system request from other monitor sensors within the first time threshold; determining whether an acknowledgement to the first master system request is received from all the other monitor sensors within a second time threshold if it is determined that the first master system request shall not be abandoned; and switching the first monitor sensor to the new master sensor if it is determined that the acknowledgement to the first master system request is received from all the other monitor sensors within the second time threshold.

According to another exemplary aspect of the present disclosure, if it is determined that there is no master system request from other monitor sensors within the first time threshold, then it is determined whether an acknowledgement to the first master system request is received from all the other monitor sensors within a second time threshold.

According to another exemplary aspect of the present disclosure, if it is determined that the first master system request shall be abandoned, then the master system part of the first monitor sensor becomes dormant and the first monitor sensor continues to operate as a monitor sensor, and one of the other monitor sensors that send the master system requests is switched to become the new master sensor according to a rule.

According to another exemplary aspect of the present disclosure, the rule is one of the following: minimum address number precedence, maximum address number precedence, and time precedence.

According to another exemplary aspect of the present disclosure, the master system part of each of the sensors includes a unique master system identifier to identify the master sensor; an information aggregation module to collect, aggregate, and analyze information from all the slave sensors; and a module of communicating to a slave system part that performs data interaction with a slave system part which belongs to the same sensor in the master system part and notifies all the other sensors in the measurement system that the master sensor already exists and the master system parts of all the other sensors shall not be activated.

According to another exemplary aspect of the present disclosure, the master system part of each of the sensors includes a system communication module to output information aggregated from all the slave sensors and accepting and interpreting commands or information requests from outside devices to the measurement system; and a system configuration module that is accessed by the system communication module and is used for parameter reading and parameter configuration of the measurement system.

According to another exemplary aspect of the present disclosure, the slave system part of each of the sensors includes an information collection and processing module to collect and process information; and a slave sensor communication module to deliver the collected and processed information to the master sensor.

According to another exemplary aspect of the present disclosure, the slave system part of each of the sensors includes a slave system number for differentiating between slave system parts of different sensors in the measurement system; a sensor configuration module that communicates with the system configuration module in the master system part that is in the same sensor or in other sensors in the same network via the slave sensor communication module, delivers measurement parameter information related to the sensor configuration, and writes the measurement parameter information into the data storage of the sensor where it locates; and a fault self-diagnosis module configured to diagnose whether a fault occurs in the sensor or measurement system to which the slave system part belongs.

According to another exemplary aspect of the present disclosure, the slave system part of each of the monitor sensors includes a fault diagnosis module to determine whether a fault occurs in the master sensor and the guard sensor.

According to another exemplary aspect of the present disclosure, the slave system part of each of the guard sensors includes a fault diagnosis module to determine whether a fault occurs in the master sensor and the monitor sensor.

According to another exemplary aspect of the present disclosure, the master system part and the slave system part in the same sensor are located on the same circuit board or on different circuit boards.

According to another exemplary aspect of the present disclosure, the circuit boards are mounted inside the sensor or outside the sensor.

Embodiments of the present invention will now be described in detail in connection with the accompanying drawings.

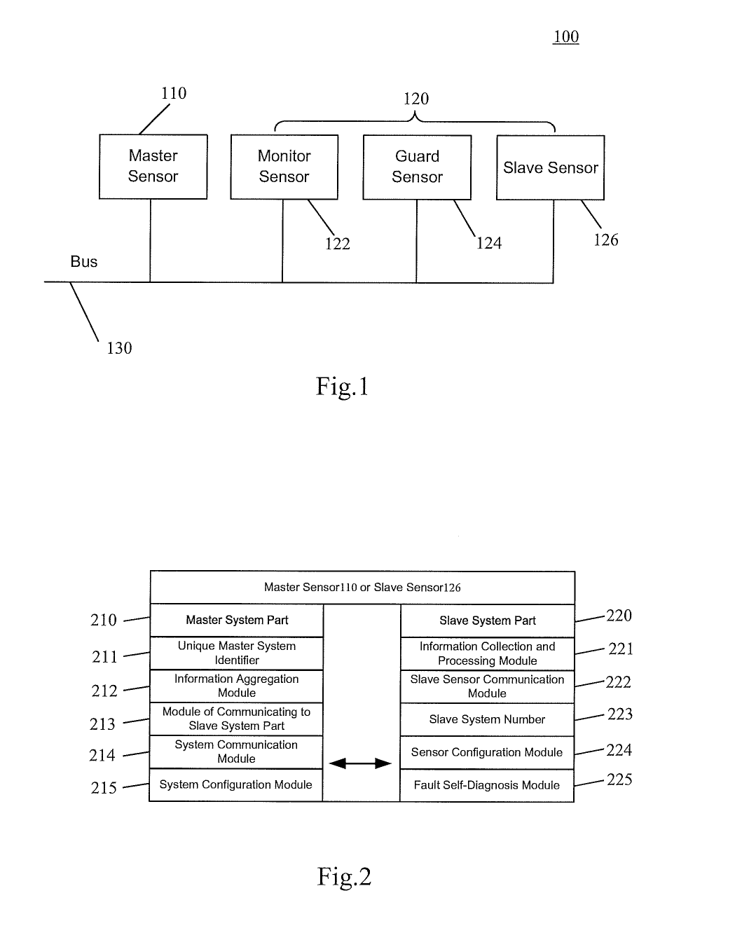

FIG. 1 shows a measurement system 100 having a plurality of sensors according to an exemplary embodiment of the present disclosure. In the measurement system 100, a plurality of sensors are coupled together via a bus 130. Each sensor is identical in physical structure and includes a master system part and a slave system part. The measurement system 100 includes one master sensor 110 and a plurality of slave sensors 120. The master system part of the master sensor 110 is activated so that it may collect, aggregate, and analyze information from all the slave sensors 120 and/or from the master sensor 110 per se. In an embodiment, the slave system part of the master sensor 110 is activated so that the master sensor 110 may collect, aggregate, and analyze information from the master sensor 110 per se in addition to information from all the slave sensors 120. In another embodiment, the slave system part of the master sensor 110 is dormant so that the master sensor 110 may only collect, aggregate, and analyze information from all the slave sensors 120. The master system part of each slave sensor 120 is dormant while the slave system part of each slave sensor 120 is activated so that each slave sensor 120 may collect and process information, and deliver the collected and processed information to the master sensor 110. When a fault occurs in the master sensor 110, one of the plurality of slave sensors 120 switches to become a new master sensor.

According to an exemplary embodiment, the plurality of slave sensors 120 include at least one monitor sensor 122. The monitor sensor 122 monitors the status of the master sensor 110 to determine whether a fault occurs in the master sensor 110, where one of the monitor sensors 122 switches to a new master sensor when a fault occurs in the master sensor 110.

According to an exemplary embodiment, the plurality of slave sensors 120 can include at least one guard sensor 124. The guard sensor 124 monitors the statuses of the master sensor 110 and the monitor sensor 122 to determine whether a fault occurs, where when fault occurs in the master sensor 110, the monitor sensor 122 asks the guard sensor 124 to select a new slave sensor to be the new monitor sensor.

According to an exemplary embodiment, the monitor sensor 122 further monitors the status of the guard sensor 124 to determine whether a fault occurs in the guard sensor 124, where when a fault occurs in the guard sensor 124, the monitor sensor 122 directly designates a new slave sensor to be the new guard sensor.

According to an exemplary embodiment, the plurality of slave sensors 120 can include slave sensors 126 that are neither monitor sensors nor guard sensors. The slave sensors 126 are used to collect information and communicate between each other.

The software and hardware of each sensor is consistent. For example, the master sensor 110, the monitor sensor(s) 122, the guard sensor(s) 124 and the slave sensor(s) 126 are identical in physical structure, but bear other functions apart from common “slave” sensor functions due to differences in functional configurations. For each sensor, the internal functional configuration is identical. The only difference between the master sensor and the slave sensor is whether the master system part inside is activated.

As shown in FIG. 1, a plurality of sensors constitute a measurement system 100 via a field bus 130. The data interaction between the master sensor 110 and the slave sensor(s) 120 is implemented via the field bus 130. The data interaction between the master sensor 110 and system peripheral(s) is implemented via the same physical field bus 130. Bus 130 may be a daisy chain bus, a star bus, or a tree bus etc. More particularly, bus 130 may be any one of the following buses: Foundation Field Bus, PROFIBUS, CAN/CAN OPEN, DeviceNet, LonWorks, ControlNet, CC-Link, CompoNet, and Industrial Ethernet.

Since the communication physical layers of all the sensors are connected together, an internal fault of any of the sensors would not influence the communication between the master sensor 110 and superior devices and other slave sensors 120 as long as it does not influence the connection of communication physical layers.

Before the operation of the measurement system 100, a sensor is first configured to be the master sensor 110, and the master system part of the master sensor 110 is activated. Then networking follows by the master system part in the master sensor 110 sending broadcast command to other sensors in the network, where the command includes a master system identifier, the number of the sensor where the master system part locates, etc. In the meantime, the master system parts in other sensors are in dormant status, while only slave system parts respond. The slave system parts record the number of the master sensor 110, send back an acknowledgement, and record in the master system part of the master sensor 110 with the numbers of all the slave sensors 120, including the number of the slave system part in the master sensor 110. The master-slave network is thus constructed, and each slave system sends back weighing data or status data according to the requirement of the master system part in the master sensor 110, and formally enters into system communication mode.

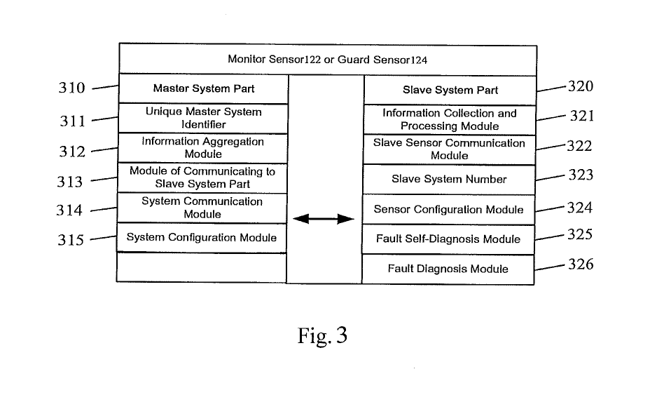

The functions of the master sensor 110, the monitor sensor(s) 122, the guard sensor(s) 124, and the slave sensor(s) 126 will be further described in the following descriptions of FIGS. 2 and 3.

FIG. 2 shows an internal functional module diagram of a master sensor 110 and a slave sensor 126 according to an exemplary embodiment of the present disclosure. As shown in FIG. 2, each of the master sensor 110 and the slave sensor 126 includes a master system part 210 and a slave system part 220. In an exemplary embodiment of the present disclosure, the master system part 210 of the master sensor 110 or the slave sensor 126 includes a unique master system identifier 211 to identify the master sensor 110; an information aggregation module 212 to collect, aggregate, and analyze information from all the slave sensors 126; and a module of communicating to slave system part 213, where the module of communicating to slave system part 213 performs data interaction with a slave system part 220 which belongs to the same sensor in the master system part 210, and notifies all the other sensors in the measurement system that the master sensor 110 already exists and the master system parts of all the other sensors shall not be activated.

In an exemplary embodiment of the present disclosure, the master system part 210 of the master sensor 110 or the slave sensor 126 includes a system communication module 214, where the system communication module 214 outputs information aggregated from all the slave sensors 126, and accepts and interprets commands or information requests from outside devices to the measurement system; a system configuration module 215 that is accessed by the system communication module 214 and is used for parameter reading and parameter configuration of the measurement system.

In an exemplary embodiment of the present disclosure, the slave system part 220 of the master sensor 110 or the slave sensor 126 includes an information collection and processing module 221 to collect and process information; and a slave sensor communication module 222 to deliver the collected and processed information to the master sensor 110.

In an exemplary embodiment of the present disclosure, the slave system part 220 of the master sensor 110 or the slave sensor 126 includes a slave system number 223 to differentiate between slave system parts of different sensors in the measurement system; a sensor configuration module 224 that communicates with the system configuration module 215 in the master system part 210 that is in the same sensor or in other sensors in the same network via the slave sensor communication module 222, delivers measurement parameter information related to the sensor configuration, and writes the measurement parameter information into the data storage of the sensor where it locates, where the measurement parameter information includes, for example, capacity, calibration data, etc.; and a fault self-diagnosis module 225 to diagnose whether a fault occurs in the sensor or measurement system to which the slave system part 220 belongs.

FIG. 3 shows an internal functional module diagram of a monitor sensor 122 and a guard sensor 124 according to an exemplary embodiment of the present disclosure. As shown in FIG. 3, each of the monitor sensor 122 and the guard sensor 124 includes a master system part 310 and a slave system part 320. The master system part 310 shown in FIG. 3 is identical to the master system part 210 shown in FIG. 2. The slave system part 320 shown in FIG. 3 differs from the slave system part 220 shown in FIG. 2 merely in that the slave system part 320 can include a fault diagnosis module 326 to determine whether a fault occurs in the master sensor 110 and the guard sensor 124. Other portions of the slave system part 320 are identical to those of the slave system part 220, and thus are not redundantly described herewith.

In an exemplary embodiment of the present disclosure, the master system part and the slave system part of the same sensor may be located on different circuit boards. The circuit boards may be mounted inside the sensor, or outside the sensor.

In an exemplary embodiment of the present disclosure, the master system part and the slave system part of the same sensor may be located on the same circuit board. The circuit board may be mounted inside the sensor, or outside the sensor.

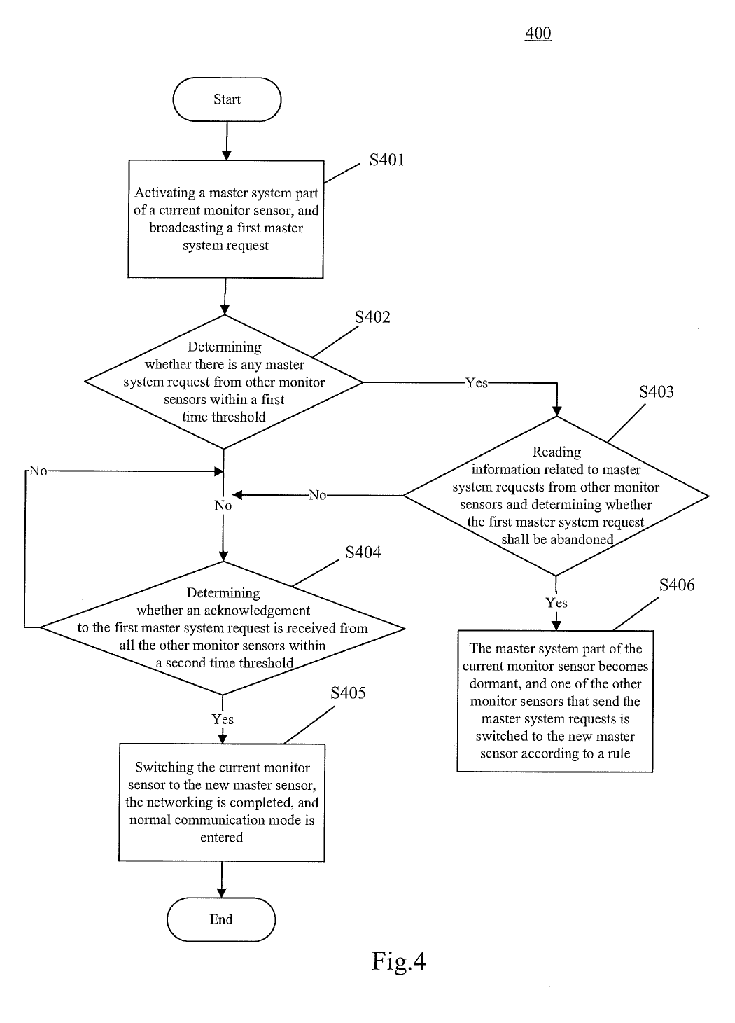

FIG. 4 shows an exemplary flow chart of a method by which a plurality of monitor sensors 122 compete to become a master sensor after a fault occurs in the master sensor 110. In an exemplary embodiment corresponding to the method shown in FIG. 4, the measurement system includes two or more monitor sensors 122. When a fault occurs in the master sensor 110, one of the two or more monitor sensors 122 switches to the new master sensor according to the method 400. In Step S401, the master system part 310 of a first/current monitor sensor 122 is activated, and a first master system request is broadcast to other monitor sensors 122 in the measurement system. The first master system request is a request intending to be the master sensor and includes a number of the current monitor sensor 122.

In Step S402, it is determined whether there is any master system request from other monitor sensors within a first time threshold. If it is determined in Step S402 that there is no master system request from other monitor sensors within the first time threshold, then the method proceeds to Step S404. If it is determined in Step S402 that there are master system requests from other monitor sensors within the first time threshold, then the method proceeds to Step S403. In Step S403, information related to the master system requests from other monitor sensors is read, and it is determined whether the first master system request shall be abandoned. If it is determined in Step S403 that the first master system request shall not be abandoned, then the method proceeds to Step S404. If it is determined in Step S403 that the first master system request shall be abandoned, then the method proceeds to Step S406.

In Step S406, the master system part 310 of the current monitor sensor 122 becomes dormant, and one of the other monitor sensors that send the master system requests is switched to the new master sensor according to a rule. The rule may be one of the following: minimum address number precedence, maximum address number precedence, and time precedence. After the networking of the measurement system is completed, the first monitor sensor 122 enters into slave sensor operation mode, and continues the original work as a monitor sensor.

In Step S404, it is determined whether an acknowledgement to the first master system request is received from all the other monitor sensors within a second time threshold. If it is determined in Step S404 that the acknowledgement to the first master system request is not received from all the other monitor sensors within the second time threshold, then the method returns to Step S404 until the acknowledgement is received from all the other monitor sensors. If it is determined in Step S404 that the acknowledgement to the first master system request is received from all the other monitor sensors within the second time threshold, then the method proceeds to Step S405. In Step S405, the current monitor sensor 122 is switched to the new master sensor. In the meantime, the numbers of all the slave sensors are recorded in the local database, the networking is completed, and the normal communication mode begins.

A master sensor of the present disclosure is derived by combining the functions of terminal and the functions of sensor so as to optimize the system. When a fault occurs in the master sensor, another slave sensor is allowed to take over so as to increase the system reliability. The measurement system of the present disclosure supports automatic multi-redundancy switching. Exemplary measurement systems disclosed herein can achieve at least the following advantages:

(1) Reduce system complexity. The master sensor is responsible for information collection and aggregation in addition to its responsibility of sensing measurement points.

(2) Increase system reliability. Any one of the sensors in the system has the ability of being a master sensor, which is multi-machine hot backup. When a fault occurs in the current master sensor, the remaining sensors negotiate according to a certain mechanism to generate a new master sensor, which continues to perform the functions of information collection, aggregation, and analyzing of the measurement system.

(3) Increase the tolerance of the system to environment. Since the tolerance of the sensors to the environment is higher compared to computer or terminal, the measurement system without any terminal or computer may tolerate harsher environment.

While the foregoing is directed to embodiments of the present invention, other embodiments of the invention may be devised without departing from the basic scope thereof, and the scope thereof is determined by the claims that follow.

It will thus be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS LIST

110 Master Sensor

122 Monitor Sensor

124 Guard Sensor

126 Slave Sensor

130 Bus

210, 310 Master System Part

211, 311 Unique Master System Identifier

212, 312 Information Aggregation Module

213, 313 Module of Communicating to Slave System Part

214, 314 System Communication Module

215, 315 System Configuration Module

220, 320 Slave System Part

221, 321 Information Collection and Processing Module

222, 322 Slave Sensor Communication Module

223, 323 Slave System Number

224, 324 Sensor Configuration Module

225, 325 Fault Self-Diagnosis Module

326 Fault Diagnosis Module

1. A measurement system comprising:
a plurality of sensors, the plurality of sensors being coupled together via a bus, each of the sensors being identical in physical structure and having a master system part and a slave system part;
one master sensor, wherein when the master system part of the master sensor is activated, the master sensor being configured to collect, aggregate, and analyze information from the slave sensors and/or from the master sensor per se; and
a plurality of slave sensors, wherein the master system part of each slave sensor is dormant while the slave system part of each slave sensor is activated, each slave sensor being configured to collect and process information and deliver the collected and processed information to the master sensor;
wherein the plurality of sensors are configured to respond when a fault occurs in the master sensor, such that one of the plurality of slave sensors will switch to become a new master sensor.

2. The measurement system of claim 1, wherein the plurality of slave sensors comprise:
at least one monitor sensor configured to monitor status of the master sensor to determine whether a fault occurs in the master sensor such that when a fault occurs in the master sensor, one of the monitor sensors will switch to the new master sensor.

3. The measurement system of claim 2, wherein the plurality of slave sensors comprise:
at least one guard sensor to monitor status of the master sensor and the monitor sensors to determine whether a fault occurs, such that when a fault occurs in the master sensor, the monitor sensors will ask the guard sensors to select a new slave sensor to be a new monitor sensor.

4. The measurement system of claim 3, wherein the monitor sensor monitors status of the guard sensor to determine whether a fault occurs in the guard sensor such that when a fault occurs in the guard sensor, the monitor sensor will directly designate a new slave sensor to be a new guard sensor.

5. The measurement system of claim 2, wherein the plurality of slave sensors comprise:
a monitor sensor configured to, when a fault occurs in the master sensor, directly switch to the new master sensor.

6. The measurement system of claim 1, wherein the plurality of slave sensors comprise:
two or more monitor sensors configured such that when a fault occurs in the master sensor, one of the two or more monitor sensors will switch to the new master sensor according to a process which includes:
activating a master system part of a first monitor sensor, and broadcasting a first master system request to other monitor sensors in the measurement system, wherein the first master system request is a request intending to be a master sensor and includes a number of the first monitor sensor;
determining whether there is any master system request from other monitor sensors within a first time threshold;
reading information related to master system requests from other monitor sensors and determining whether the first master system request shall be abandoned if it is determined that there is a master system request from other monitor sensors within the first time threshold;
determining whether an acknowledgement to the first master system request is received from all the other monitor sensors within a second time threshold if it is determined that the first master system request shall not be abandoned; and
switching the first monitor sensor to become the new master sensor if it is determined that the acknowledgement to the first master system request is received from all the other monitor sensors within the second time threshold.

7. The measurement system of claim 6, wherein if it is determined that there is no master system request from other monitor sensors within the first time threshold, then it is determined whether an acknowledgement to the first master system request is received from all the other monitor sensors within a second time threshold.

8. The measurement system of claim 6, wherein if it is determined that the first master system request shall be abandoned, then the master system part of the first monitor sensor will become dormant and the first monitor sensor will continue to operate as a monitor sensor, and one of the other monitor sensors that sent a master system request is switched to become a new master sensor according to a rule.

9. The measurement system of claim 8, wherein the rule is one of the following:
minimum address number precedence, maximum address number precedence, and time precedence.

10. The measurement system of claim 1, wherein the master system part of each of the sensors comprises:
a unique master system identifier to identify the master sensor;
an information aggregation module to collect, aggregate, and analyze information from all the slave sensors; and
a module of communicating to slave system part that performs data interaction with a slave system part which belongs to the same sensor as the master system part and notifies all the other sensors in the measurement system that the master sensor already exists and the master system parts of all the other sensors shall not be activated.

11. The measurement system of claim 10, wherein the master system part of each of the sensors comprises:
a system communication module configured to output information aggregated from all the slave sensors and to accept and interpret commands or information requests from outside devices to the measurement system; and
a system configuration module that is accessed by the system communication module and configured for parameter reading and parameter configuration of the measurement system.

12. The measurement system of claim 1, wherein the slave system part of each of the sensors comprises:
an information collection and processing module to collect and process information; and
a slave sensor communication module to deliver the collected and processed information to the master sensor.

13. The measurement system of claim 12, wherein the slave system part of each of the sensors comprises:
a slave system number for differentiating between slave system parts of different sensors in the measurement system;
a sensor configuration module configured to communicate with the system configuration module in the master system part that is in the same sensor or in other sensors in the same network via the slave sensor communication module, deliver measurement parameter information related to the sensor configuration, and write the measurement parameter information into the data storage of the sensor where it locates; and
a fault self-diagnosis module configured to diagnose whether a fault occurs in the sensor or measurement system to which the slave system part belongs.

14. The measurement system of claim 13, wherein the slave system part of each of the monitor sensors comprises:
a fault diagnosis module to determine whether a fault occurs in the master sensor and the guard sensor.

15. The measurement system of claim 13, wherein the slave system part of each of the guard sensors comprises:
a fault diagnosis module to determine whether a fault occurs in the master sensor and the monitor sensor.

16. The measurement system of claim 1, wherein in that the master system part and the slave system part of the same sensor are located on a same circuit board or on different circuit boards.

17. The measurement system of claim 16, wherein the circuit boards are mounted inside the sensor or outside the sensor.

18. The measurement system of claim 6, wherein the master system part of each of the sensors comprises:
a unique master system identifier to identify the master sensor;
an information aggregation module to collect, aggregate, and analyze information from all the slave sensors; and
a module of communicating to slave system part that performs data interaction with a slave system part which belongs to the same sensor as the master system part and notifies all the other sensors in the measurement system that the master sensor already exists and the master system parts of all the other sensors shall not be activated.

19. The measurement system of claim 6, wherein the slave system part of each of the sensors comprises:
an information collection and processing module to collect and process information; and
a slave sensor communication module to deliver the collected and processed information to the master sensor.
